(19) United States
(12) Patent Application Publication
(10) Pub. No.: US 2007/0102572 A1
(43) Pub. Date: May 10, 2007

(54) Method for making gas turbine elements and corresponding element

(75) Inventor: Rudolf Bohdal, Karlsfeld (DE)

Correspondence Address: DAVIDSON, DAVIDSON & KAPPEL, LLC, 485 SEVENTH AVENUE, 14TH FLOOR, NEW YORK, NY, 10018, US

(73) Assignee: MTU Aero Engines Gmbh, Muenchen (DE)

(21) Appl. No.: 10/564,076

(22) PCT Filed: Jul. 8, 2004
(86) PCT No.: PCT/DE04/01467

§ 371 Date: Jan. 10, 2006

(30) Foreign Application Priority Data
Jul. 11, 2003 (DE) 10331397.4

(51) Int. Cl. B64C 39/00

(52) U.S. Cl. 244/62

(57) ABSTRACT

A vane segment and a method is provided for manufacturing elements, namely gas turbine vane segments, in particular for an aircraft power train. Each vane segment comprises at least two vanes, one segment being produced by injection moulding of metal powder of several vanes.

The present invention relates to the method for manufacturing components, namely vane segments, for a gas turbine, in particular for an aircraft engine. Furthermore, the present invention relates to such a component, namely a vane segment, for a gas turbine.

Modern gas turbines, in particular aircraft engines, must fulfill extremely demanding requirements with regard to reliability, weight, performance, economy, and service life. In recent decades, in particular in the civil aviation sector, aircraft engines have been developed which are able to meet the aforementioned requirements and have reached a high level of technical perfection. In the development of aircraft engines, among other things the choice of material, the search for new, suitable materials, and the search for new manufacturing methods play a decisive role.

The most important materials used currently for aircraft engines or other gas turbines are titanium alloys, nickel alloys (also known as superalloys), and high-strength steels. The high-strength steels are used for shaft components, drive components, compressor housings and turbine housings. Titanium alloys are typically used as material for compressor components. Nickel alloys are suitable for the hot components of the aircraft engine.

Numerous methods for manufacturing vanes, in particular guide vanes, for aircraft engines are known from the related art. Known, related-art methods for manufacturing vanes, in particular guide vanes, include forging and investment casting. Usually vanes in the compressor area are forged components, while as a general rule all moving vanes and guide vanes for the turbine are investment casting components. Manufacturing vanes via electrochemical machining (ECM) is also known from the related art. According to the related art, in the aforementioned manufacturing processes for manufacturing vanes, each vane is manufactured individually. The known, related-art methods are expensive.

On this basis, the object of the present invention is to propose a novel method for manufacturing components, namely vane segments, of a gas turbine and a corresponding component.

This object is achieved by a method for manufacturing components, namely of vane segments, for a gas turbine, in particular for an aircraft engine, in which each vane segment includes at least two vanes, the vane segment which includes a plurality of vanes being manufactured via powder metallurgy injection molding. It has been found according to the present invention that by manufacturing vane segments having at least two vanes via powder metallurgy injection molding the manufacturing costs may be significantly reduced. Preferably the guide vane segment includes three or four guide vanes.

According to a first preferred refinement of the method according to the present invention, in order to manufacture one vane segment from at least two vanes, molded bodies are manufactured separately for each vane via injection molding, the molded bodies for the vanes being joined together prior to a debinding process to form a molded body for the vane segment. The joining together of the vanes to form the vane segment is performed in the “green” state.

According to a second, alternative preferred refinement of the method according to the present invention, in order to manufacture one vane segment from at least two vanes, molded bodies are manufactured separately for each vane via injection molding, the molded bodies for the vanes undergoing a separate debinding process, and the molded bodies for the vanes then being joined together to form a molded body for the vane segment. The joining together of the vanes to form the vane segment is performed in the pre-sintered state.

According to a third, alternative preferred refinement of the method according to the present invention, in order to manufacture one vane segment from at least two vanes, a shared molded body for the vane segment, i.e., for all vanes of the vane segment, is manufactured via injection molding. The joining together of the vanes to form a vane segment is performed via injection in a tool.

The component according to the present invention is defined in independent Patent Claim 13.

Preferred refinements of the present invention are indicated in the dependent claims and the description below.

Exemplary embodiments of the present invention are described in greater detail based on the drawing, without being limited thereto.

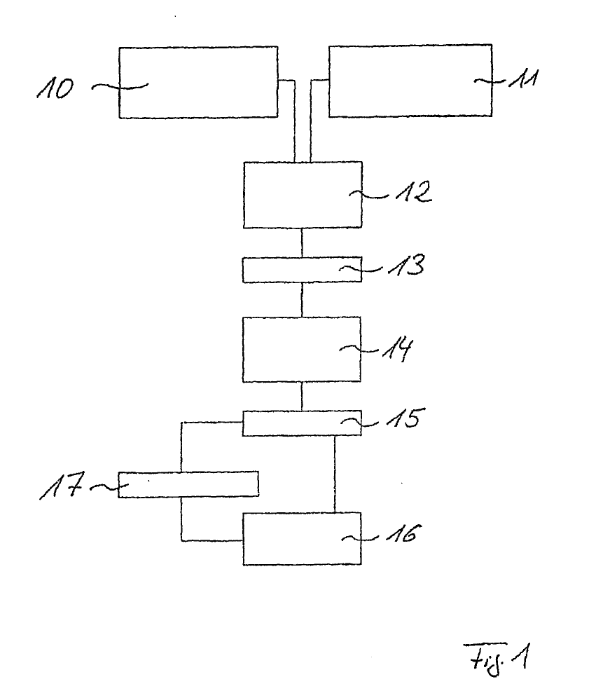

FIG. 1 shows a block diagram illustrating the individual powder metallurgy injection molding method steps; and

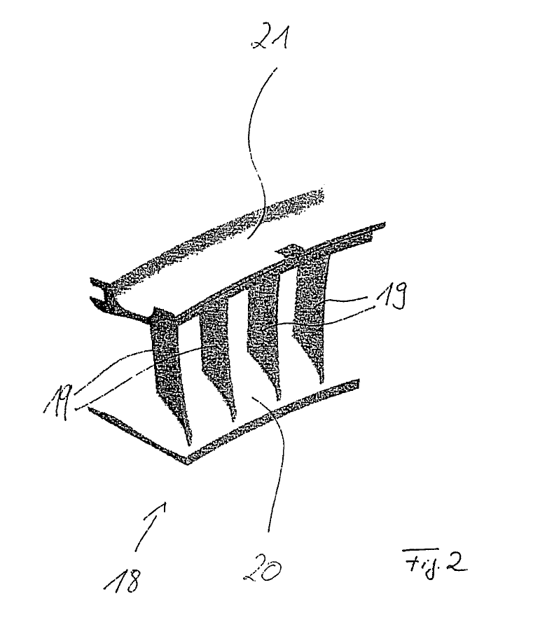

FIG. 2 shows a perspective side view of a vane segment according to the present invention.

The present invention relates to manufacturing vane segments of a gas turbine, in particular of an aircraft engine, via powder metallurgy injection molding. Powder metallurgy injection molding is also known as metal injection molding (MIM). The details of the method according to the present invention will be described later; first, however, the basic elements of powder metallurgy injection molding are described below, with reference to FIG. 1.

In a first step 10, a metal powder, hard metal powder or ceramic powder is prepared. In second step 11, a binding agent and if necessary a plasticizer, e.g., a wax, is prepared. In method step 12, the metal powder prepared in method step 10 and the binding agent and plasticizer prepared in method step 11 are mixed and homogenized so that a homogeneous material is formed. The metal powder preferably accounts for between 50% and 70% of the volume of the homogeneous material. Accordingly, the proportion of the homogeneous material accounted for by the binding agent and plasticizer fluctuates between roughly 30% and 50% .

This homogeneous material which includes metal powder, binding agent and plasticizer is subjected to further processing via injection molding in step 13. During injection molding molded bodies are formed. These molded bodies already have all the typical features of the components to be manufactured. In particular, the molded bodies have the geometric shape of the component to be manufactured. However, their volume is greater due to the binding agent content and plasticizer content.

In subsequent step 14, the binding agent and the plasticizer are removed from the molded bodies. Method step 14 is known as the debinding process or dewaxing step. The binding agent and plasticizer may be removed in various ways. Normally this is accomplished via fractional thermal decomposition or evaporation. Further options include the removal of the thermally liquefied binding agent and plasticizer using capillary forces, sublimation, or solvents.

Following the debinding process in step 14, the molded bodies are sintered in step 15. During sintering, the molded bodies are compressed to form the components having the final geometric properties. During sintering, the molded bodies shrink accordingly, it being necessary for the dimensions of the molded bodies to shrink evenly in all three spatial directions. Depending on the binding agent content and plasticizer content, the linear shrinkage is between 10% and 20%. Sintering may also be carried out in the presence of various protective gases or in vacuum.

Following sintering, the finished component is ready, as shown in step 16 in FIG. 1. If necessary, following sintering (step 15), the component may be subjected to a refining process in step 17. However, the refining process is optional. It is also possible for an installation-ready component to be ready directly after sintering.

The scope of the present invention includes manufacture of one vane segment from a plurality of vanes via powder metallurgy injection molding. Combining powder metallurgy injection molding with joining together a plurality of individual vanes to form vane segments makes it possible to significantly reduce manufacturing costs. It is preferable to join together three or four guide vanes to form one guide vane segment manufactured via powder metallurgy injection molding.

Thus FIG. 2 shows a vane segment 18 having four guide vanes 19, the four guide vanes 19 being joined via inner cover band 20 and outer cover band 21. A section of inner cover band 20 and of outer cover band 21 are assigned to each guide vane 19, the four individual guide vanes 19 being joined via the respective sections of inner cover band 20 and outer cover band 21, thereby forming vane segment 18.

The joining together of individual vanes 19 to form vane segment 18 via powder metallurgy injection molding may be carried out in three different ways. A first option for joining together the vanes to form one vane segment is known as joining in the green state. A second option for joining together the vanes to form a vane segment is known as joining in the pre-sintered state, and a third option is known as joining via injection in a tool.

Before the details of the three options for joining are described, it is important to note that joining in the green state and joining via injection in a tool yield better joining results than joining in the pre-sintered state. This is because when joining in the green state and joining via injection in a tool, the surfaces to be joined are in closer contact with one another, which has a favorable impact on the joining result. However, satisfactory results may also be achieved via joining in the pre-sintered state.

In the case of the first option for joining, which is known as joining in the green state, in order to manufacture one vane segment from a plurality of vanes, molded bodies are manufactured separately via injection molding for each vane including the appropriate sections of the outer cover band and inner cover band. These molded bodies, in which the binding agent and plasticizer are still present, are then joined together to form one molded body for the entire vane segment. To accomplish this, the molded bodies for the individual vanes are positioned behind one another or respectively next to one another in accordance with the desired sequence of the vanes, the respective adjacent sections of the outer cover band and inner cover band touching one another. The secure positioning of the molded bodies for the individual vanes relative to one another may be accomplished via a device, e.g., via clamps. The thus formed molded body for the entire vane segment is then subjected to a uniform debinding process to remove the binding agent and plasticizer. When the binding agent is softened and removed from the molded body, minor unevenness in the joining surfaces that touch each other is compensated for, and thus suitable contact surfaces are formed. The molded body for the entire vane segment is then preferably dewaxed and pre-sintered. The bond between the individual vanes is already so strong following pre-sintering that the means for fixing the individual molded bodies for the individual vanes may be released. After this, the actual sintering of the molded body for the vane segment is carried out, until the vane segment to be manufactured is ready. In the case of this joining option, it is possible to form a good bond between the individual vanes of the vane segment which is essentially indistinguishable from the bond in the basic material.

An alternative to joining in the green state is to join in the pre-sintered state. In the case of joining in the pre-sintered state, to manufacture one vane segment from a plurality of vanes, the individual molded bodies for each vane must also be first manufactured separately via injection molding. These molded bodies for the individual vanes separately undergo a debinding process in order to dewax the molded bodies and remove the binding agent and plasticizer from the molded bodies for the individual vanes. Furthermore, according to this alternative, the molded bodies for the individual vanes are pre-sintered separately. During pre-sintering, there is no shrinking process, i.e., the molded bodies do not experience any significant shrinkage. In this pre-sintered state, the molded bodies for the individual vanes are joined together to form a molded body for the vane segment. This molded body for the vane segment is then subjected to uniform sintering. During sintering, the molded bodies for the individual vanes must be secured or fixed in position relative to one another. This may be accomplished for example using clamps. However, as the clamps may place constraints on the freedom of movement of the molded body during sintering, better results are achievable with joining in the green state than with joining in the pre-sintered state. The constraints placed on the freedom of movement during sintering may in fact result in undesirable deformations and cracks in the finished component. However, joining molded bodies for the individual vanes in the pre-sintered state has the advantage that the wall thicknesses of the individual components and not the wall thickness of the joined component have to be taken into account during the debinding process, in particular during dewaxing. Thus in the case of joining in the pre-sintered state, less processing time is required for the debinding process. Accordingly, in the case of joining in the pre-sintered state, the vane segments may be manufactured more quickly.

Another option is to perform joining via injection in a tool. In the case of this option, in order to manufacture one vane segment from a plurality of vanes, a joint molded body for the vane segment, i.e., for all vanes thereof, is manufactured during injection molding. This molded body for the entire vane segment is then subjected as a single unit to a uniform debinding process followed by subsequent uniform sintering. Also in the case of this option, an excellent bond between the individual vanes may be manufactured.

The option involving joining via injection in a tool may be used in particular for vanes having filigree cooling channels. In a first work step, a vane half is manufactured. This vane half and a core which forms the cooling channels are inserted into a mold cavity for injection molding which is subsequently filled completely. The core is then melted out, manufacturing the molded body for the vane segment. After insertion of the one vane half into the mold cavity and before filling of the mold cavity, the already inserted vane half may be pre-warmed to improve binding.

It is important to note that it is of course also feasible within the scope of the invention to manufacture one vane segment from for example four vanes, using two sub-vane-segments each including two vanes. The two sub-vane-segments each including two vanes may be manufactured for example via injection in a tool, these two sub-segments then being joined to each other in the green state. Other combinations are also feasible.

The present invention proposes for the first time manufacturing vane segments for gas turbines from a plurality of vanes via powder injection molding. The vane segment is preferably a guide vane segment having a plurality of guide vanes for an aircraft engine.

1-16. (canceled)

17. A method for manufacturing vane segments for a gas turbine comprising the steps of:
providing a plurality of vanes,
manufacturing a vane segment from the plurality of vanes via powder metallurgy injection molding.

18. The method as recited in claim 17, wherein the vane segment is designed as a guide vane segment and includes at least two guide vanes.

19. The method as recited in claim 18, wherein the guide vane segment includes three or four guide vanes.

20. The method as recited in claim 17, wherein the step of manufacturing comprises the steps of:
mixing a metal powder having a binding agent to form a homogeneous material;
forming at least one molded body from the homogeneous material via injection molding,
subjecting the at least one molded body to a debinding process,
compressing the at least one molded body via sintering to form the vane segment.

21. The method as recited in claim 20, wherein, in that in order to manufacture one vane segment from at least two vanes,
a molded body for each vane is manufactured separately via injection molding, and
the molded bodies are joined together prior to the debinding process to form one molded body for the vane segment.

22. The method as recited in claim 21, wherein the molded bodies for the vanes are joined together prior to the debinding process in the green state to form one molded body for the vane segment.

23. The method as recited in claim 21, wherein the one molded body for the vane segment is then subjected to a uniform debinding process and uniform sintering in the debinding and sintering steps.

24. The method as recited in claim 23, wherein,in that to manufacture one vane segment from at least two vanes:
a molded body for each vane is manufactured separately via injection molding,
the molded bodies for the vanes undergo separate debinding processes, and
the molded bodies for the vanes are subsequently joined together to form one molded body for the vane segment.

25. The method as recited in claim 24, wherein the molded bodies for the vanes are joined together in a presintered state to form one molded body for the vane segment.

26. The method as recited in claim 24, wherein the one molded body for the vane segment is then subjected to uniform sintering in the sintering step.

27. The method as recited in claim 20, wherein, to manufacture one vane segment from at least two vanes, a joint molded body for all vanes of the vane segment is manufactured via injection molding.

28. The method as recited in claim 27, wherein the joint molded body for the vane segment is subjected to a uniform debinding process and uniform sintering.

29. A component for a gas turbine, comprising
a vane segment manufactured from a plurality of vanes via powder metallurgy injection molding.

30. The component as recited in claim 29, wherein the vane segment is designed as a guide vane segment and includes at least two guide vanes.

31. The component as recited in claim 30, wherein the guide vane segment includes three or four guide vanes.
